(19) United States
(12) Patent Application Publication
(10) Pub. No.: US 2012/0066048 A1
(43) Pub. Date: Mar. 15, 2012

(54) SYSTEM AND METHOD FOR SINGLE COUPON KEY CODE REDEMPTION OF MULTIPLE COUPONS

(76) Inventors: Steven B. Foust, Spring Park, MN (US); Kenneth Wyatt Richards, Plymouth, MN (US); Vickie M. Johnson, Spring Park, MN (US)

(21) Appl. No.: 13/209,230

(22) Filed: Aug. 12, 2011

Related U.S. Application Data
(60) Provisional application No. 61/373,067, filed on Aug. 12, 2010.

(51) Int. Cl. G06Q 30/02

(52) U.S. Cl. 705/14.26

(57) ABSTRACT

A system and method for conveying coupons using an electronic device comprises receiving with a computer, a keyword transmitted from the electronic device, associating, with a computer, the keyword with a Key Code, wherein the Key Code is associated with the one or more coupons, and transmitting from the computer to the electronic device, a single electronic message including the Key Code and one or more coupons, each of the one or more coupons including one or more images.

### PRIORITY INFORMATION

This application claims the benefit of priority of U.S. Provisional Patent Application Ser. No. 61/373067 filed on Aug. 12, 2010 and entitled “SYSTEM AND METHOD FOR SINGLE COUPON KEY CODE REDEMPTION OF MULTIPLE COUPONS,” which is hereby incorporated by reference in its entirety.

### FIELD

This disclosure generally relates to a system and method for the use of, conveyance, and controlling a key code for simplifying the redemption of multiple coupons. The key code is a single code or bar code that represents multiple coupons. More specifically, the system provides various methods of conveyances to the consumer and uses of the key code, allowing for the redemption of multiple coupons by means of the key code to generate customer convenience and loyalty. Furthermore, this disclosure relates to the system and method for utilizing a mobile cellular apparatus for consumer viewing of coupons to be redeemed by a single key code. The key code is delivered to the consumer by such medium as direct mail printed media, web based pages or cellular apparatus for display which is used to redeem multiple coupons for product purchased. This disclosure further relates to unique methods of distribution of coupon key codes to consumers facilitating the subscription by cellular apparatus and the redemption of coupons.

### BACKGROUND

In marketing, a coupon is a ticket or document that can be exchanged for a financial discount or rebate when purchasing a product. Customarily, coupons are issued by manufacturers of consumer-packaged goods or by retailers and are redeemed in retail stores as a sales promotion. Coupons are often widely distributed through mail, magazines, newspapers, the Internet, and mobile devices such as cellular apparatus.

Online retailers offer discounts or rebates as internet coupons. Internet coupons are also known as “coupon codes”, “promotional codes”, “promotion codes”, “discount codes”, “key codes”, “promo codes”, “shopping codes”, “voucher codes” or “source codes”. Internet coupons typically provide for reduced cost or free shipping, a specific dollar or percentage discount, or some other offer to encourage consumers to purchase specific products and services from a specific retailer.

Another trend is the use of a cellular apparatus for the receipt of coupon offerings that are in a barcode form, where the barcode type is readable by a compatible scanners found at the retail point of sale. The purpose of conveying barcodes to cellular apparatus, be it a loyalty card or a coupon, ticket, etc, is to enhance customer convenience. Since many customers carry their cellular apparatus with them, they have ready access to the coupons and loyalty cards that are conveyed to their cellular apparatus. Furthermore, there is a reduced cost associated with not having to print coupons in newspapers, magazines and booklets, and the associated reduction in paper use is environmentally friendly.

Currently, coupons are distributed as individual offerings and each coupon must be scanned individually for redemption whether it is a paper coupon or a barcode image on a cellular apparatus. Individual scanning is time consuming for the customers since it is done in line at the point of sale and takes additional time on the retail end as well.

For reasons of customer convenience, retailer resource savings, loyalty generation, and enhancement of the shopping experience there is a substantial need for the system and method described herein.

### SUMMARY

A system and method for the redemption of multiple coupons by using a single Voucher that incorporates a Key Code. The Key Code is a single bar code representing a specific offering of multiple product discounts or coupons, herein called an electronic Voucher Offering, that when redeemed result in customer convenience, generation of customer loyalty and support of retail loyalty club membership. Furthermore, it follows that multiple types of customer loyalty and coupon offerings and programs can utilize this system and method dependent upon the desired needs, sophistication and target market. Customer convenience can be further generated by providing multiple means of conveyance and multiple means of access of the Voucher and its Key Code and the Voucher's associated Voucher Offering to the customer or loyalty club member, for example, by printed media, direct mail, internet web based or cellular apparatus. In addition, multiple Vouchers may be combined and conveyed to the consumer as a single printed media, electronically via the Internet, Web pages, email or directly to a subscribing cellular apparatus wherein each Voucher may have a unique Key Code having a different redemption period in a chronological order and when a Voucher is redeemed during its redemption period automatically redeems its Voucher Offering of multiple coupons for matching product when purchased.

In one embodiment the Voucher(s) and associated Voucher Offering(s) are related to a specific merchant's product discount offerings.

In one embodiment, the Voucher incorporates a Key Code that is a unique alphanumeric, alphabetic or numeric string that may be represented as a bar code that is associated with at least two or more product discount coupons, herein called a Voucher Offering. When the Voucher Key Code is redeemed, by scanning, manual entry or other means, all associated coupons of the Voucher Offering that match the products purchased are automatically redeemed by means of computer software code at the Point of Sales (POS) or back-office system of the retailer.

In one embodiment, the Key Code is representative of a Voucher Offering that may only be redeemed for a finite period prior to its expiration date.

In one embodiment, the Key Code is unique for each different Voucher Offering of a specific merchant and each Voucher may be redeemed during a finite time prior to its expiration date.

In one embodiment, the Key Code is not unique for each different Voucher Offering of a specific merchant and each Voucher may be redeemed for the Voucher Offering for its specified redemption period and therein a form of loyalty card for customer convenience.

In one embodiment, a single medium for conveyance to the consumer that may be printed media or any digital electronic form is composed of multiple Vouchers that are in a chronological redemption interval order for timed release, and each Voucher having a Key Code that is unique for redemption of its associated Voucher Offering during its valid redemption interval. For example, and not limited hereto, each Voucher's unique Key Code represents a unique Voucher Offering for week one through week eight with a corresponding expiration date during which a consumer can redeem the corresponding Voucher for all coupons of the Voucher Offering that apply for that period and use each subsequent week's Voucher accordingly.

In one embodiment, the Voucher Offering coupons all have the same percentage discount for the same or different manufacturer's products.

In one embodiment, the Voucher Offering coupons all have the same monetary discount for the same or different manufacturer's product.

In one embodiment, the Voucher Offering coupons are representative of one manufacturer's product.

In one embodiment, the Voucher Offering coupons are for different products having different discount values and may be of the same or different manufacturers.

In one embodiment, the Voucher is published for the consumer in printed media and conveyed to the consumer, but not limited hereto, by means of direct mail service, newsprint or at the retail location.

In one embodiment, a single publication of printed media contains multiple Vouchers wherein each Voucher may represent a single merchant or multiple merchants' Voucher Offerings. Furthermore, the Vouchers may have different or same redemption period and expiration dates or be in a time release chronological order as defined on the printed media. The printed media can be conveyed to the consumer via various means, including but not limited to, the direct mail service, newsprint, coupon books, retail location.

In one embodiment, the Voucher or multiple Vouchers are published in electronic form on a retailer or other Internet web site or conveyed to consumer by email from which the consumer may access the Vouchers and print them for redemption.

In one embodiment, the Voucher or multiple Vouchers are published in electronic form and conveyed to the consumer's cellular apparatus for redemption at the appropriate POS by means of scanning or entering the number into the POS system by the retail attendant.

In one embodiment, the cellular apparatus opts-in (registers) using a specific phone number or shortcode to send an opt-in text with the merchants keyword to Cellular apparatus coupon system to subscribe for receipt the Voucher and Voucher Offering in electronic form on the cellular apparatus. The cellular apparatus may opt-out at any time by use of the appropriate stop or equivalent text message to the same phone number or shortcode.

In one embodiment, the coupons of which the Voucher Offering is composed and representative is published in electronic form and conveyed to a subscribed consumer cellular apparatus by SMS and MMS messaging cellular services.

In one embodiment, any future Voucher Offerings for the subscribed merchant may be automatically conveyed to all subscribed consumer cellular apparatus by SMS and MMS messaging cellular services.

In one embodiment Voucher Offerings may be downloaded by the consumer from a designated Internet Web Site to their respective web enabled cellular apparatus.

In another embodiment, there is a device for facilitating a conveyance of coupons, comprising a keyword that is enterable to a electronic device and is unique to a merchant, the keyword being associated with one or more coupons receivable by the electronic device after entry of the keyword. The device may further comprise a printed media including the keyword disposed thereon.

The device may further comprise additional keywords, such as for example, in a form of a list, wherein each of the additional keywords is enterable to an electronic device and is unique to a merchant, each of the additional keywords being associated with one or more additional coupons receivable by the electronic device.

In another embodiment, a method for conveying coupons using any of the embodied device(s) disclosed herein, comprises receiving with a computer, a keyword transmitted from an electronic device, performing an association using a computer, wherein the keyword is associated with a Key Code, wherein the Key Code being associated with one or more coupons, and then transmitting from the computer to the electronic device, an electronic message including the Key Code. In an embodiment, the electronic message is only a single electronic message. In an embodiment, the single electronic message includes one or more coupons and can be displayed on the display of an electronic device. Accordingly, a plurality of coupons can be transmitted and/or accessed for using by a user, with a delivery of the single electronic message.

In another embodiment, a method also includes displaying at least one of the coupons on a display of the electronic device. The method may include displaying at least one of the coupons on a display of the electronic device that is associated with the Key Code transmitted from the computer to the electronic device.

At least one of the coupons displayed on a display of the electronic device can include an image. The image may be that of a promotional item associated with a coupon and/or other images.

In another embodiment, a method for conveying coupons using an electronic device comprises receiving with a computer, a keyword transmitted from the electronic device, associating, with a computer, the keyword with a Key Code, wherein the Key Code is associated with the one or more coupons, and transmitting from the computer to the electronic device, a single electronic message including the Key Code and one or more coupons, each of the one or more coupons including one or more images.

### DESCRIPTION OF THE DRAWINGS

The drawings, which are not necessarily drawn to scale, illustrate generally, by way of example, but not by way of limitation, various embodiments discussed in this application.

FIG. 1 is an illustration of one embodiment of the overview of the flow process of a onetime use Voucher and associated Key Code and redemption of its Voucher Offering coupons through the purchase process.

FIG. 2a is an illustration of one embodiment of printed media with multiple chronological time release Vouchers and subscription to merchant's loyalty club via cellular apparatus for conveyance of Voucher Offerings to a cellular apparatus.

FIG. 2b is an illustrative example of one embodiment of printed media with multiple chronological time release Vouchers and subscription to merchant's loyalty club via cellular apparatus for conveyance of Voucher Offerings to a cellular apparatus.

FIG. 3 is an illustration of one embodiment of the subscription process to join a merchant loyalty club by way of cellular apparatus; receive the Voucher and Voucher Offering on the cellular apparatus and redemption at the POS.

FIG. 4a is an illustration of one embodiment of a Voucher list or directory on printed media with multiple merchant Vouchers where each Key Code is associated with and representative of an individual merchants unique Voucher Offering.

FIG. 4b is an illustrative example of one embodiment of a merchant list or directory on printed media by which a cellular apparatus may subscribe for merchant Vouchers and Voucher Offering coupons using merchant's unique coupon code.

### DETAILED DESCRIPTION

In the following detailed description, reference is made to the accompanying drawings, which form a part hereof, and in which is shown, by way of illustration, specific embodiments in which the inventive concepts may be practiced. These embodiments are described in sufficient detail to enable those skilled in the art to practice the invention, and it is to be understood that the embodiments may be combined or used separately, or that other embodiments may be utilized and that design, implementation, and procedural changes may be made without departing from the spirit and scope of the inventive concepts. The following detailed description provides examples, and the scope of the present invention is defined by the claims to be added and their equivalents.

The term “Key Code” as used herein refers to an alphanumeric or numeric string of numbers. The Key Code represents more than one coupon for redemption and furthermore may be represented as a barcode of any type that is able to be scanned by a Point of Sale scanner or the alphanumeric or numeric string can be entered manually by the POS attendant into the POS system for redemption of coupons for product purchased for which it represents.

The term “Key Code Offering” used herein is in reference to and by example refer to an aggregate of coupons or a single coupon that the Key Code represents and the POS will recognize for redemption when the Key Code is scanned or entered into the POS.

The term “Voucher” as used herein is the printed media that consists of at least the merchants name, a Key Code, expiration date and may further consists of a Voucher Offering coupon sample, a redemption period and instructions for cellular apparatus subscription and receipt of Voucher Offering coupons on cellular apparatus.

For the ease of understanding, the embodiments are described using the term “cellular apparatus.” However, it will be understood that the term “cellular apparatus” means an electronic device or a wireless communication device that is generally handheld and can transmit and receive data using a wireless network. An electronic device can include, but not be limited to, cellular apparatus, personal digital assistant (PDA), handheld computer, tablet computer, portable media player, two-way radio, global positioning system device, or any type of device, known now or in the future, that enables data communication capability between entities. The term “wireless” has become an all-encompassing word used to describe communications in which electromagnetic waves or RF (rather than some form of wire) carry a signal over part of or the entire communications path. The transmission media used to carry the signal from the cellular apparatus to its point of termination can consist of wired or wireless media. Wireless communications can be via radio frequency communication, microwave communication, or infrared (IR) short-range communication. Applications may involve point-to-point communication, point-to-multipoint communications, broadcasting, cellular networks and other wireless networks. While the term “cellular apparatus” is used as an all-encompassing term for wireless devices, for the sake of convenience and simplicity of description and understanding, the conveyance of Voucher Offering coupons and the Key Codes utilize SMS and MMS cellular messaging services and the web when the cellular apparatus is web enabled. It is to be understood that the Cellular Coupon System and methods are not limited to the use of cellular telephone devices and cellular telecommunication systems only, and that other wireless apparatuses, devices and methods can be used. Ttransmission and/or reception of signals may be made via a wired network and/or a wireless network, such as, for example, the internet, cellular network, SMS, WiFi, 3G network, 4G network, satellite, and/or any combination thereof.

The tend “shortcode” as used herein refer to special telephone numbers, significantly shorter than full telephone numbers, that are used to address SMS and MMS messages from mobile phones or fixed phones. There are two types of shortcodes: dialing and messaging.

The term “shortcode” as used herein refer to special telephone numbers, significantly shorter than full telephone numbers, that can be used to address SMS and MMS messages from mobile phones or fixed phones. There are two types of shortcodes: dialing and messaging. Shortcodes are designed to be easier to read and remember than normal telephone numbers. Like telephone numbers, shortcodes are unique to each operator at the technological level. Even so, providers generally have agreements to avoid overlaps. In some countries, such as the United States, some classes of numbers are inter-operator (U.S. inter-operator numbers are called Common Short Codes. For example, in the United States, common shortcodes are four, five or six digits, such as 2222, 12345, 898989).

The cellular apparatus, as describe herein, can utilize Short Messaging Service (SMS) and Multimedia Messaging Service (MMS), smart apparatus applications, and wireless web browsing to communicate with the system that conveys Voucher Offerings, Vouchers, coupons and their associated barcodes and text to be displayed on the receiving cellular apparatus.

The term “printed media” as used herein refers to any type of printed matter by which the Voucher and its Key Code and the Voucher Offering may be conveyed to the consumer that by way of example but not limited hereto may be newsprint, printed card, magazine, etc. Printed media can also refer to display received on the screen of the cellular apparatus.

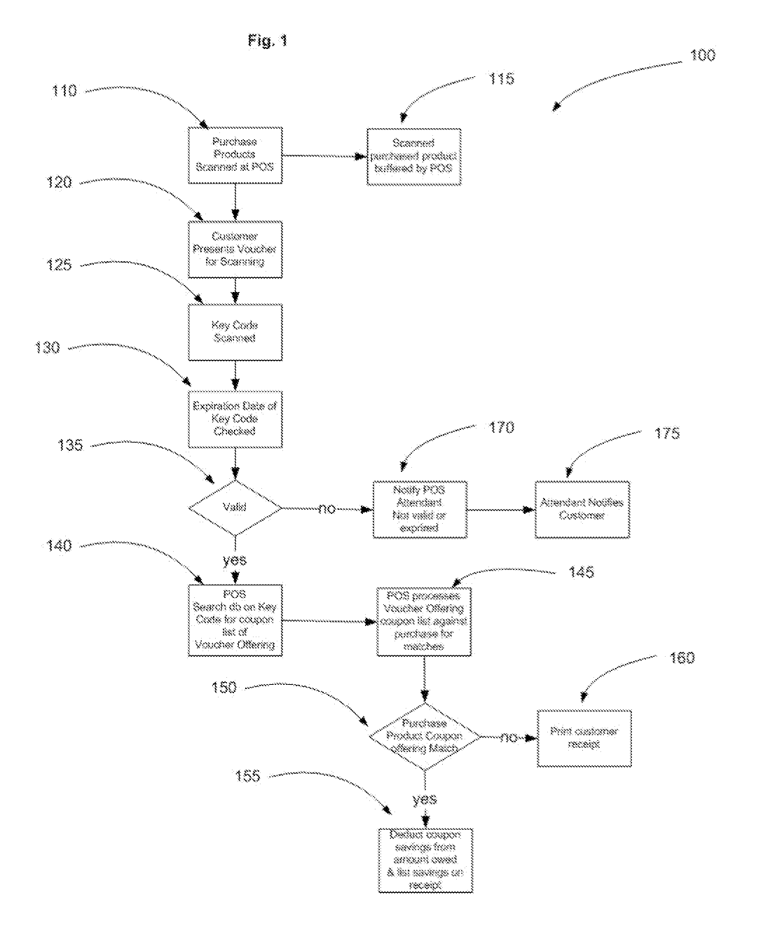

The term “Cellular Coupon System” or “System”, used interchangeably herein, and as referred to in FIGS. 1-3 refers to the computer system having the software and hardware required to store Key Code and Voucher information; correlate coupons with a Key Code to become the Voucher Offering; opt-in (subscribe) and opt-out (unsubscribe) the cellular apparatus with the loyalty club; and convey the Key Codes and Voucher Offering coupons to the cellular apparatus. The System may be a single integrated system or distributed across a network where different components may be at different physical locations each providing a specific function such as the retail POS, retail back-office system, Key Code and Voucher Offering database of coupons and the mechanism for opt-in and opt-out and conveyance of such information to a cellular apparatus.

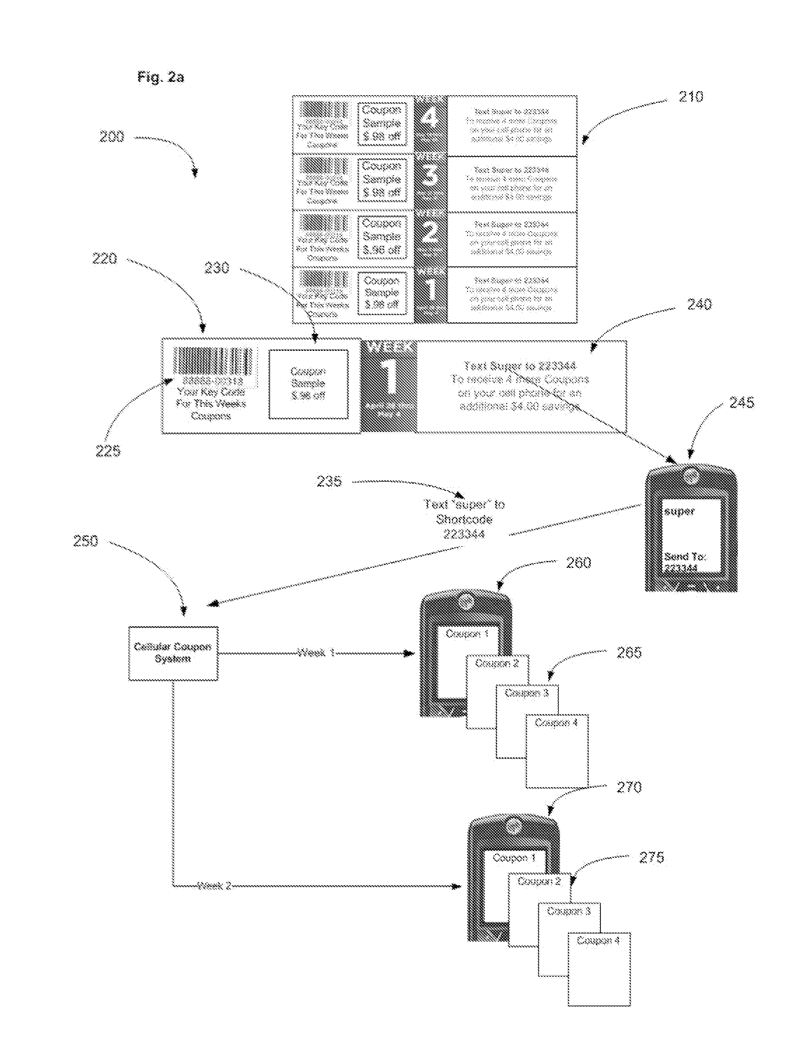

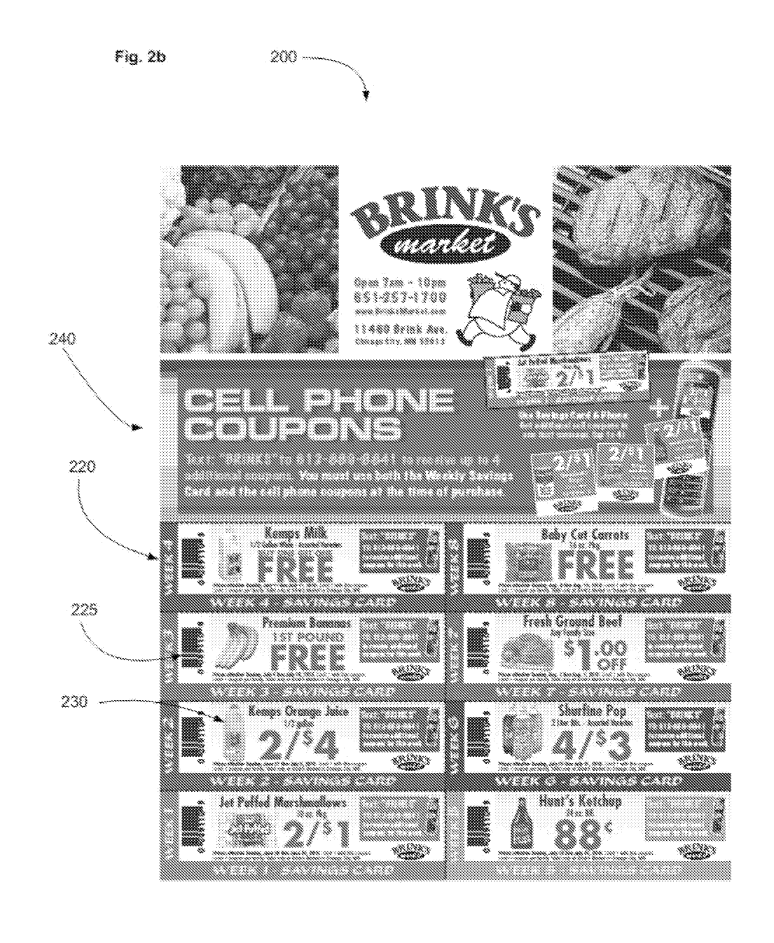

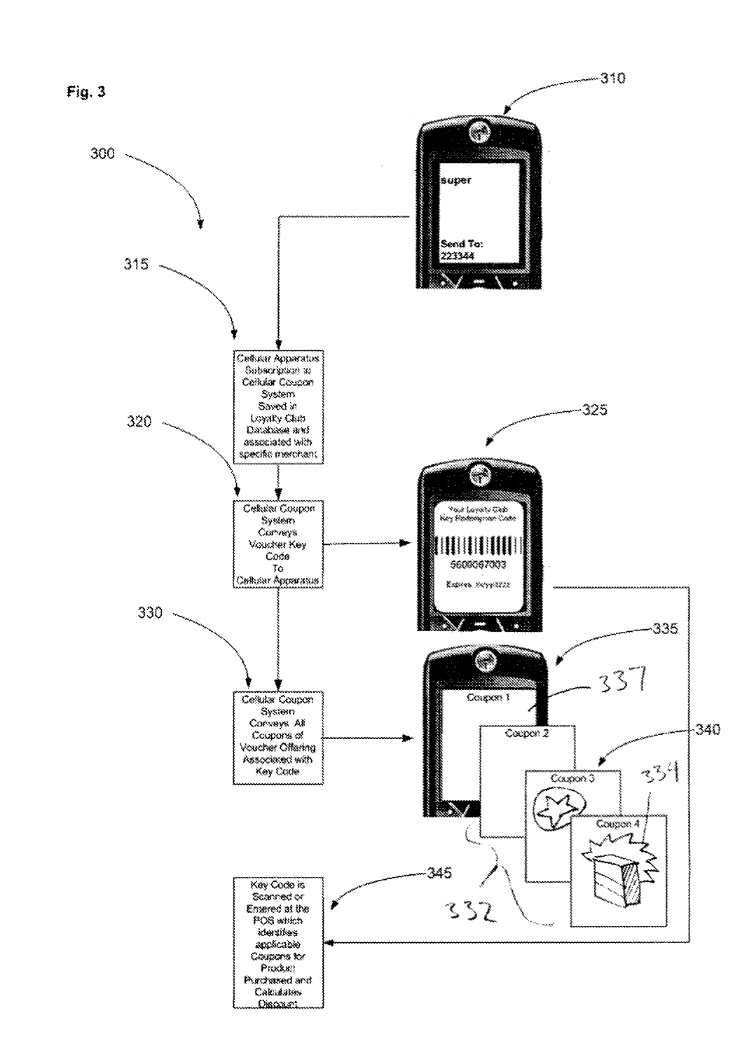

It should be noted that in FIGS. 2 and 3 the cellular apparatuses shown within each figure number are the same cellular apparatus throughout the figure. Each illustration of the cellular apparatus is assigned a unique reference number to denote that the screen shot of the cellular apparatus illustrates a different function or embodiment of the cellular apparatus than a different illustration of the same cellular apparatus within the same figure number.

Described herein is a system and method for the redemption of multiple coupons by using a single representative Key Code. The Key Code is a single bar code representing a specific offering of multiple coupons, herein called a Voucher Offering, resulting in customer convenience, generation of customer loyalty and support of retail loyalty club membership. Furthermore, it follows that multiple types of customer loyalty and coupon offerings and programs can be generated utilizing this system and method dependent upon the desired needs, sophistication and target market. Customer convenience can be further generated by providing multiple means of access and multiple means of conveyance of the Voucher Offering and Key Code to the customer or loyalty club member, for example, by printed media, internet web based or cellular apparatus.

It is understood that even though the system and method for the redemption of multiple coupons using a single representative Key Code is discussed herein as being based on receiving coupon keywords and Key Codes on a weekly basis, the time period can vary based on the needs of the consumer or the merchant. For example, the system and method can follow any time period interval, including but not limited to, daily, weekly, bi-weekly, monthly, yearly, etc.

FIG. 1 illustrates one embodiment of a flow process overview for a onetime use Key Code and redemption of its Voucher Offering coupons through the purchase process 100. Products for purchase are scanned at the POS register 110 and are buffered in the POS memory 115. Upon completion of product scanning, the consumer presents the Voucher by way of printed media or cellular device 120. The bar code representing the Key Code is scanned or entered manually at the POS 125. The system checks the Key Code expiration date 130 and determines if the Key Code date is valid 135. If the Key Code date is not valid, the system notifies the POS attendant 170 whereupon the attendant can notify the customer 175 that the Key Code has expired. If the Key Code date is valid, the POS searches its database for the Key Code and the associated coupon offerings or Voucher Offering 140. The POS processes the Voucher Offering coupon list and compares the list against the products purchased 145 to determine if there are any matches 150 between the products purchased and the coupon offerings. If no products match the offering the receipt is printed 160 and the transaction is complete. If a product or products purchased matches the Voucher Offering the discount savings are automatically deducted from the total and the offerings and associated savings are listed on the printed receipt 155 thereby ending the transaction.

FIG. 2a illustrates one embodiment of printed media containing multiple time release Key Codes 200. The printed media is an example of a card 210 containing four weekly interval Key Codes 225 and other relevant information regarding the coupon offerings. The printed media can be included on a chronologically stacked coupon mailer as described in U.S. Pat. No. 7,543,853 to Foust, titled “Chronologically Stacked Coupon Mailer” and filed June 8, 2005, which is herein incorporated by reference. As shown by example, a detail of the Week 1 Voucher 220 can contain such information as the Key Code 225 which may be a reusable Key Code or a unique Key Code for each week, a sample coupon 230 to visually notify the consumer what is being offered, the week number and the valid redemption period that can include an expiration date, and instructions detailing the process to obtain additional Voucher Offering coupons on a cellular apparatus 235 and short code. The instructions can include, for example, the phone number to connect to and the keyword to enter, as well as details on any other offerings that may be provided.

As shown in the embodiment illustrated in FIG. 2a, the printed media contains two separate offerings per week or per specified time period, a Key Code 225 for that time periods Voucher Offering and a sample coupon 230 of the offering, that is further illustrated when received on the cellular apparatus 260, 265. The printed media also contains a shortcode number and coupon keyword 235 that, upon texting 240 to a cellular apparatus, provide the consumer with additional coupon offerings that will be sent to the cellular apparatus 260, 270. The shortcode is a unique number or numeric code that is assigned to the Cellular Coupon System 250 and which is recognized by cellular carriers or aggregators. By texting the coupon keyword, for example “Super”, to the shortcode, the text message containing the coupon keyword is received by the Cellular Coupon System 250 which represents an opt-in subscription for the merchant's associated offering represented by the Key Code 225. The coupon keyword, for example “Super”, may be any alphanumeric or numeric combination that is assigned to, registered to, and retained by a specific merchant or offeror. By retaining a specific coupon keyword, the consumer continues to identify the specific coupon keyword with a specific merchant or offeror, e.g., Target, Costco, Walgreens, or SuperValu. By texting the coupon keyword related to and retained by an offeror, the consumer subscribes to the coupon offerings of the specific offeror and the system automatically delivers the coupon offerings, of the specific offeror, to the consumers' cellular apparatus. In another embodiment, the consumer can review the offerings and can opt-out of receiving the offerings on the cellular apparatus.

As illustrated, the keyword “Super” is texted to shortcode “223344” 240. The keyword is received by the Cellular Coupon System 250. The cellular apparatus is subscribed to and connected to the appropriate merchant cellular loyalty club based upon the text message body “Super”. The cellular apparatus phone number can become the loyalty membership number. The system conveys the appropriate week Voucher Offering coupons to the cellular apparatus 260 for review by the consumer 265, which in this example is week 1. A subscriber of week 1 offerings will automatically receive all future weeks' offerings on their cellular apparatus 270 and the received coupons can be individually reviewed 275 without having to follow the subscription or opt-in process. However, any new subscriber may opt-in and subscribe at any time during any one of the weekly offerings to receive that weeks' and all subsequent weeks' offerings so long as the coupon keyword, for example “Super”, is the same for each week. Otherwise, if each week has a unique coupon keyword, the consumer must follow the opt-in subscription process each week.

FIG. 2b is an example of a printed media Chronological Time Release Mailer 200 with eight weeks of Vouchers 220 and respective Key Code 225, and sample Voucher Offering coupon 230. The printed media is an example of a chronologically stacked coupon mailer as described in U.S. Pat. No. 7,543,853 to Foust, titled “Chronologically Stacked Coupon Mailer” and filed Jun. 8, 2005, which is herein incorporated by reference. Upon receipt of the printed media, the consumer enters the shortcode, in this case a telephone number and “Brinks” the coupon code 240 contained in the mailer header receive the associated Voucher Offering 230 on the consumer's cellular apparatus based upon the date the cellular apparatus subscribes. Each consecutive weeks Voucher Offering will be conveyed and received by the cellular apparatus automatically for redemption by the consumer during the redemption interval.

It is understood that the Cellular Coupon System checks the date the cellular apparatus subscribed and conveys the current valid Voucher Offering base upon its date to the cellular apparatus. Furthermore, the printed media may require a different keyword for each Key Code for each weekly interval. In one embodiment, the Cellular Coupon System can also subscribe the consumer by a one-time texting of the keyword and the Cellular Coupon System will automatically convey all subsequent interval Voucher Offerings to the cellular apparatus on a set interval basis, thus requiring no further action from the consumer. However, as discussed above, if the coupon keyword differs from one time period to the next, the consumer must text the new coupon keyword for the next time period to receive the offering.

FIG. 3 is an illustration of one embodiment of the subscription process to join a loyalty club using a cellular apparatus 300 and to receive the Key Code and Voucher Offering Coupons on the cellular apparatus for redemption of the Voucher Offering. The consumer inputs, by texting, a coupon keyword to the shortcode 310. The text message or coupon keyword is received by the Cellular Coupon System 315 and the cellular apparatus is automatically subscribed to the appropriate merchant cellular loyalty club based upon the coupon keyword. In one embodiment, the cellular apparatus number becomes the loyalty membership number. Once the cellular apparatus is subscribed, the Cellular Coupon System conveys the Key Code 320 to the cellular apparatus 325 and display the Key Code 320 on the display of the cellular apparatus then conveys 330 the Voucher Offering coupons 332 to the cellular apparatus 335 for being displayed by a display of the cellular apparatus 337 for review by the consumer 340. One or more of the coupons 332 may include an image 334. It is understood that the Key Code 320 and/or Voucher Offering coupons 332 may be conveyed to the cellular apparatus 325 in a single message. At the point-of-sales, the consumer presents the Key Code text message on the cellular apparatus 325 to the POS attendant for scanning 345 or manual input. The POS system will search the database for Voucher Offering coupon matches with products purchased based upon the Key Code scanned or manually input at the POS.

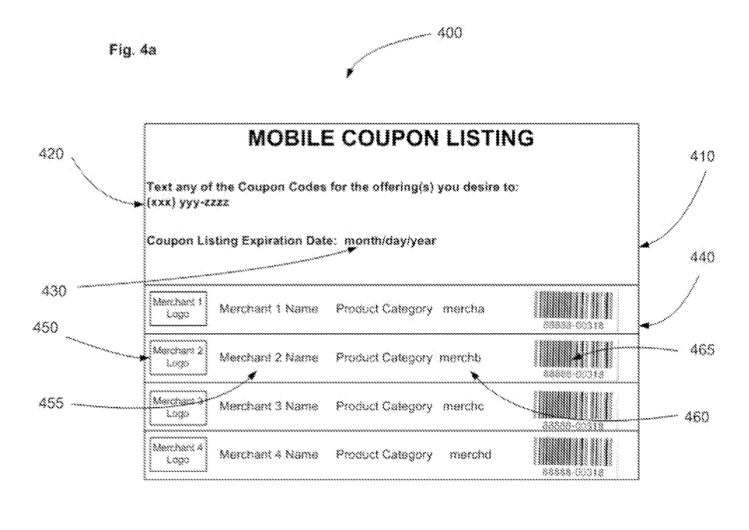

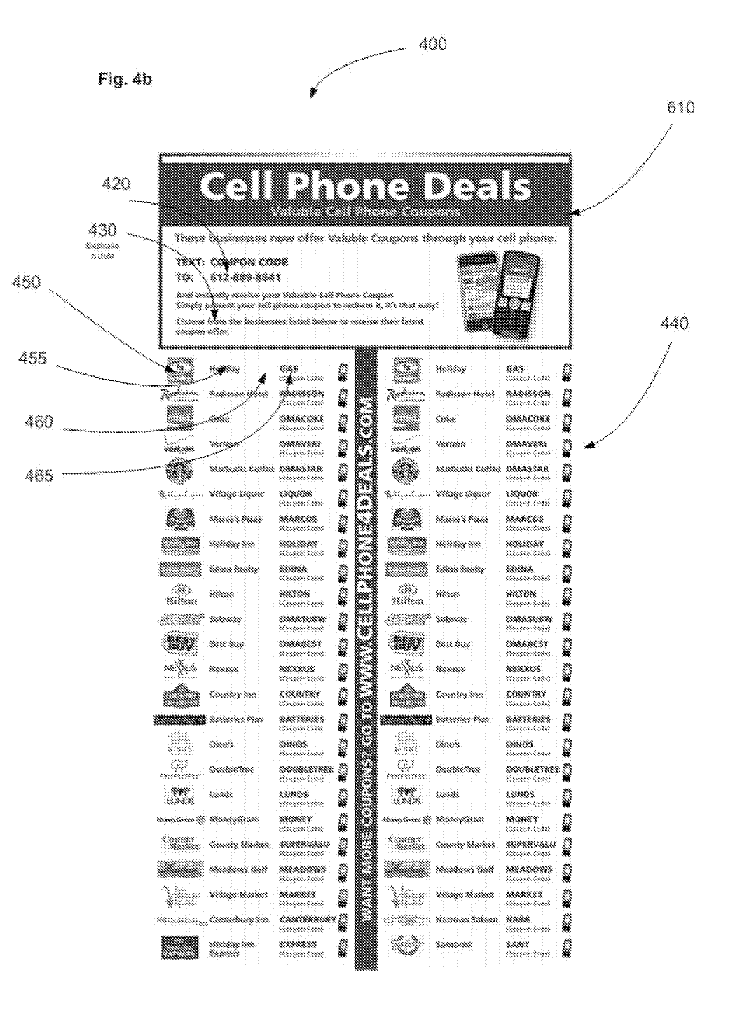

FIG. 4a illustrates an embodiment of a Merchant Voucher list or directory of multiple Vouchers on printed media 400. Each Voucher listing 440 represents an individual merchant's 450 unique Voucher Offering. The Voucher listing 400 is comprised of a header 410 containing, for example, the cellular number or shortcode 420 to which the Coupon Codes 460 can be texted by a cellular apparatus and may further incorporate an expiration date 430 of the Voucher list 400. The header 410 is not limited to the shortcode 420 or expiration date 430 and can contain other information such as, for example, advertising or instructions. Each Voucher 440 is comprised at least of the individual merchant logo 450, the individual merchant name 455, the Coupon Code 460 for each Voucher, and the Key Code 465. Each Voucher 640 could further contain, for example, expiration dates, offering details, and offering sample coupon.

FIG. 4b is an example of a printed media Coupon Code list 400 with actual merchant logos 450, merchant names 455, and unique Coupon Codes 465. The printed media can be, for example, a chronologically stacked coupon mailer as described in U.S. Pat. No. 7,543,853 to Foust, titled “Chronologically Stacked Coupon Mailer” and filed Jun. 8, 2005, which is herein incorporated by reference. Upon receipt of the printed media, the consumer enters the shortcode 420 and then texts the unique Coupon Code 465 to receive the associated Key Code and Voucher Offering on the consumer's cellular apparatus. The coupon offering is then presented to the retail merchant for redemption.

The examples and embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A device for facilitating a conveyance of coupons, comprising:
a keyword that is enterable to an electronic device and is unique to a merchant,
the keyword being associated with one or more coupons receivable by the electronic device after entry of the keyword into the electronic device.

2. The device of claim 1, further comprising a printed media including the keyword disposed thereon.

3. The device of claim 1, further comprising additional keywords,
wherein each of the additional keywords is enterable to the electronic device and is unique to a merchant,
each of the additional keywords being associated with one or more additional coupons receivable by the electronic device.

4. A method for conveying coupons using the device of claim 1, comprising:
receiving with a computer, the keyword transmitted from the electronic device;
associating, with the computer, the keyword with a Key Code, wherein the Key Code is associated with one or more coupons; and
transmitting from the computer to the electronic device, an electronic message including the Key Code.

5. The method of claim 4, wherein the electronic message is a single electronic message.

6. The method of claim 5, wherein the single electronic message includes the one or more coupons, each of the one or more coupons including one or more images.

7. The method of claim 4, further comprising:
displaying at least one of the coupons on a display of the electronic device that is associated with the Key Code transmitted from the computer to the electronic device.

8. The method of claim 7, wherein at least one of the coupons displayed on a display of the electronic device includes an image.

9. A device to facilitate a conveyance of coupons, comprising:
a Key Code configured to be associated with multiple coupons;
the Key Code is readable by a scanner; and
the multiple coupons are redeemable after scanning the Key Code.

10. The device of claim 9, wherein the Key Code is disposed on printed media.

11. The device of claim 9, further comprising a plurality of Key Codes.

12. The device of claim 11, wherein the plurality of Key Codes can be chronologically ordered and time released.

13. The device of claim 11, wherein each of the plurality of Key Codes is unique.

14. The device of claim 9, further comprising an alphanumeric keyword that is enterable to a cellular apparatus and is unique to a merchant, the keyword is associated with multiple coupons, which are retrievable by the cellular apparatus after entry of the keyword.

15. The device of claim 9, wherein the multiple coupons are receivable by the cellular device by subscription or by download from the internet to the cellular device.

16. A method of Key Code conveyance to facilitate distribution of multiple coupons, comprising:
transmitting a Key Code, the Key Code being associated with multiple coupon offerings;
receiving the Key Code by way of the Key Code having been scanned; and
distributing multiple coupon offerings based on their association with the Key Code, so that the multiple coupon offering can be redeemed.

17. The method of claim 16, wherein the Key Code is disposed on printed media.

18. The method of claim 16, further comprising receiving a keyword from a cellular apparatus from which the keyword has been entered, the keyword being associated with multiple coupon.

19. The method of claim 18, wherein the keyword is unique to a specific merchant.

20. The method of claim 16, wherein the multiple coupon offerings are conveyable to the cellular apparatus by subscription or by download from the interne to the cellular apparatus.
